(19) United States
(12) Patent Application Publication
(10) Pub. No.: US 2026/0212768 A1
(43) Pub. Date: Jul. 23, 2026

(54) OWNSHIP VEHICLE COLLISION AVOIDANCE SYSTEM

(71) Applicant: Honeywell International Inc., Charlotte, NC (US)

(72) Inventor: Petr Casek, Brno (CZ)

(21) Appl. No.: 19/033,175

(22) Filed: Jan. 21, 2025

(51) Int. Cl. G08G 5/80; G08G 5/26; G08G 5/59; G08G 5/74

(52) U.S. Cl. CPC G08G 5/80; G08G 5/26; G08G 5/59; G08G 5/74

(57) ABSTRACT

An onboard computing system of an ownship vehicle comprising processing circuitry configured to: determine a presence of an obstacle in a planned route for the ownship vehicle; determine a avoidance route for the obstacle; transmit the avoidance route to an external computing system; determine whether the onboard computing system is in communication with the external computing system; in response to a determination that the onboard computing system is in communication with the external computing system, cause the ownship vehicle to avoid the obstacle based on information received via the communications circuitry from the external computing system; and in response to a determination that the onboard computing system is not in communication with the external computing system, cause the ownship vehicle to proceed along the avoidance route, the avoidance route comprising a change to a vertical component of the planned route.

### TECHNICAL FIELD

The disclosure relates to aviation systems and more specifically to aircraft collision avoidance systems.

### BACKGROUND

Aircraft, both manned and unmanned, may travel along planned flight paths and may need to adjust flight paths to avoid obstacles (e.g., terrain obstacles) in the path of the aircraft.

### SUMMARY

In general, the disclosure describes systems, methods, and devices for causing an ownship vehicle (e.g., an unmanned aerial vehicle (UAV) to avoid obstacles in the path of the ownship vehicle. The ownship vehicle may operate autonomously and/or may be operated by an external operator in communication with the ownship vehicle. When the external operator controls the ownship vehicle, the external operator may control the movement of the ownship vehicle to avoid obstacles in the path of the ownship vehicle.

During operation of the ownship vehicle communications channel between the operator and the ownship vehicle may become degraded and/or severed. In such examples, the ownship vehicle may be autonomously navigated (e.g., based on sensed signals from sensor(s) on the ownship vehicle) to avoid obstacles in the path of the ownship vehicle, e.g., without input from the operator. Ownship vehicle may autonomously navigate in a restricted capacity (e.g., compared to operation of the ownship vehicle by the operator). Ownship vehicle may switch between autonomous control and/or remote control by the operator based on the status of the communications channel between the operator and the ownship vehicle.

Causing the ownship vehicle to switch between autonomous and remote control to avoid obstacles based on the status of the communications channel may provide several technical advantages. Switching from remote to autonomous control in the event of a degradation of the communications channel may improve the ability of the ownship vehicle to avoid obstacles and/or reduce a reaction time between detection of an obstacle and avoidance of the obstacle by ownship vehicle, e.g., when there is a loss of signal (LoS) between the operator and the ownship vehicle. Causing the ownship vehicle to autonomously navigate in the restricted capacity (e.g., limited to vertical adjustments to the path of travel) may allow the ownship vehicle to avoid obstacles while reducing a likelihood of collision between the ownship vehicle and other objects (e.g., other obstacles, other vehicles) and/or other risks to the ownship vehicle (e.g., performance degradation by the ownship vehicle, wear and/or failure of components of the ownship vehicle).

In some examples, this disclosure describes an onboard computing system of an ownship vehicle, the onboard computing system comprising: communications circuitry; and processing circuitry configured to: determine a presence of an obstacle in a planned route for the ownship vehicle; determine an avoidance route for the obstacle; transmit, via the communications circuitry, the avoidance route to an external computing system; determine whether the onboard computing system is in communication with the external computing system; in response to a determination that the onboard computing system is in communication with the external computing system, cause the ownship vehicle to avoid the obstacle based on information received via the communications circuitry from the external computing system; and in response to a determination that the onboard computing system is not in communication with the external computing system, cause the ownship vehicle to proceed along the avoidance route, the avoidance route comprising a change to a vertical component of the planned route.

In some examples, this disclosure describes a method comprising: determining, by processing circuitry of an onboard computing system of an ownship vehicle, a presence of an obstacle in a planned route; determining, by the processing circuitry, an avoidance route for the obstacle; transmitting, by the processing circuitry and via communications circuitry of the onboard computing system, the avoidance route to an external computing system; determining, by the processing circuitry, whether the onboard computing system is in communication with the external computing system; causing, by the processing circuitry and in response to a determination that the onboard computing system is in communication with the external computing system, the ownship vehicle to avoid the obstacle based on information received from the external computing system via the communications circuitry; and causing, by the processing circuitry and in response to a determination that the onboard computing system is not in communication with the external computing system, the ownship vehicle to proceed along the avoidance route, wherein the avoidance route comprises a change to a vertical component of the planned route.

In some examples, this disclosure describes a computer-readable medium comprising instructions that, when executed by processing circuitry of a onboard computing system of an ownship vehicle, causes the processing circuitry to: determine a presence of an obstacle in a planned route for the ownship vehicle; determine an avoidance route for the obstacle; transmit, via communications circuitry of the onboard computing system, the avoidance route to an external computing system; determine whether the onboard computing system is in communication with the external computing system; in response to a determination that the onboard computing system is in communication with the external computing system, cause the ownship vehicle to avoid the obstacle based on information received via the communications circuitry from the external computing system; and in response to a determination that the onboard computing system is not in communication with the external computing system, cause the ownship vehicle to proceed along the avoidance route, the avoidance route comprising a change to a vertical component of the planned route.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a conceptual diagram illustrating an example ownship vehicle operation system for an ownship vehicle, in accordance with one or more techniques of this disclosure.

FIG. 2 is a block diagram illustrating an example ownship vehicle operation system of FIG. 1.

FIG. 3 is a flow chart illustrating an example technique for avoiding obstacle(s) by the ownship vehicle operation system of FIGS. 1-2.

FIG. 4 is a flow chart illustrating an example technique for operating the ownship vehicle by the ownship vehicle operation system of FIGS. 1-2.

### DETAILED DESCRIPTION

The disclosure describes systems, methods, and devices for operating an ownship vehicle to avoid obstacles in the path of the ownship vehicle. An ownship vehicle operating system may transition between autonomous navigation of the ownship vehicle and remote operation of the ownship vehicle by an external operator based on a status of a communications channel between the ownship vehicle and an external computing system. When the ownship vehicle detects, via sensors on the ownship vehicle, that there are obstacles in a path of the ownship vehicle and that there is a degradation and/or loss of signal (LoS) in the communications channel to the external computing system, the ownship vehicle may autonomously navigate to avoid the obstacles in the path. The ownship vehicle may autonomously navigate in a more restricted manner than the remote operation of the ownship vehicle. The ownship vehicle may transition from the autonomous navigation mode to a remote navigation mode in response to a re-establishment and/or an improvement of the communications channel to the external computing system.

While the ownship vehicle is primarily described herein with respect to an unmanned aerial vehicle (UAV), the ownship vehicle may include any other types of vehicles including, but not limited to, an aircraft, a motor vehicle, an automobile, a watercraft, or any type of remote-operated vehicle. Obstacles for the ownship vehicle may include, but are not limited to, terrain obstacles, other vehicles, individuals in the path of the ownship vehicle, avoidance zones for the ownship vehicle, or the like.

The systems, methods, and devices may provide several technical advantages over collision avoidance systems of other vehicles. Transitioning between operation of the ownship vehicle in an autonomous mode and a remotely operated mode based on the status of the communications channel between the ownship vehicle and the external computing system may allow the ownship vehicle to be operated in a more accurate manner (e.g., in a remote operation mode) while allowing the ownship vehicle to more rapidly avoid obstacles (e.g., in an autonomous operation mode) in the event of a loss of communication between the ownship vehicle and the operator. Transitioning between autonomous and remote operation modes may also reduce power consumption by the ownship vehicle and/or reduce a likelihood of a collision between the ownship vehicle and an obstacle (e.g., by providing for a backup operation mode in the event of the LoS with the external computing system. Restricting the types of maneuvers the ownship vehicle may undertake in the autonomous operation mode may allow the ownship vehicle to avoid obstacles while reducing a likelihood of collision between the ownship vehicle and other objects (e.g., other obstacles, other vehicles), e.g., as a result of specific types of maneuvers undertaken by the ownship vehicle. Restricting the types of maneuvers the ownship vehicle may undertake in the autonomous operation mode may also reduce risks to ownship vehicle from an ownship perspective, e.g., resulting from performance degradation of the ownship vehicle and/or from wear and/or failure of components of the ownship vehicle (e.g., engine(s) of the ownship vehicle).

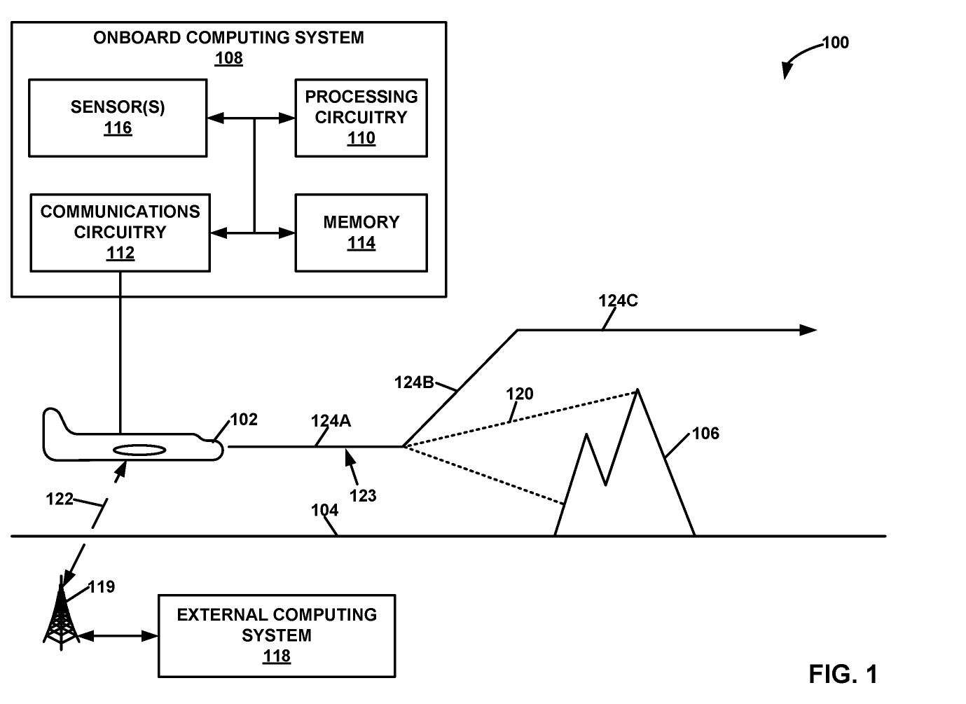

FIG. 1 is a conceptual diagram illustrating an example operation of an ownship vehicle 102, in accordance with one or more techniques of this disclosure. Ownship vehicle operation system 100 (alternatively referred to herein as “system 100”) may include ownship vehicle 102, onboard computing system 108 disposed on ownship vehicle 102, and an external computing system 118 in communication with onboard computing system 108 via antenna 119. Onboard computing system 108 may include one or more components including, but are not limited to, processing circuitry 110, communications circuitry 112, memory 114, and sensor(s) 116.

External computing system 118 may transmit information to and/or receive information from an operator of system 100. The operator of system 100 may be external to ownship vehicle 102. External computing system 118 may be coupled to antenna 119. Communications circuitry 112 may establish a communications channel 122 with antenna 119 and may transmit information and/or queries to and/or receive instructions from external computing system 118 via communications channel 122. Communications channel 122 may be alternatively referred to herein as data link 122.

Processing circuitry 110 may control operation of ownship vehicle 102 based on received instructions from external computing system 118. In some examples, processing circuitry 110 determines that there is a degradation of signal and/or a LoS from external computing system 118 along communications channel 122. Degradation of signal and/or LoS may include, but are not limited to, a greater than threshold delay in responses from external computing system 118 in response to a query from processing circuitry 110, a lack of communication from external computing system in response to the query from processing circuitry 110, an at least partial corruption of a response from external computing system 118 in response to the query, or the like. In response to a determination of the degradation of signal and/or the LoS, processing circuitry 110 may retrieve and execute instructions stored in memory 114 to autonomously operate ownship vehicle 102.

Sensor(s) 116 onboard ownship vehicle 102 may sense signals 120 from an environment surrounding ownship vehicle 102. Signals 120 may indicate positions of obstacle(s) 106, ground 104, and/or other objects in the environment surrounding ownship vehicle 102. Processing circuitry 110 may transmit signals 120 to external computing system 118 via communications circuitry 112 and/or store signals 120 in memory 114. External computing system 118 may present indications of the surrounding environment based on signals 120 to the operator and receive instructions from the operator. External computing system 118 may transmit the received instructions to processing circuitry 110 of onboard computing system 108 via antenna 119 to cause processing circuitry 110 to operate ownship vehicle 102 based on the received instructions. In some examples, where processing circuitry 110 is autonomously operating ownship vehicle 102, processing circuitry 110 operates ownship vehicle 102 based at least in part on indications of the surrounding environment based on signals 120.

Ownship vehicle 102 may travel above ground 104 along planned route 123 (alternatively referred to herein as “path of travel 123”). Ownship vehicle 102 may travel along planner route 123 by executing maneuver 124A. Onboard computing system 108 (e.g., processing circuitry 110 of onboard computing system 108) may cause ownship vehicle 102 to perform maneuver 124A based on instructions from external computing system 118.

Processing circuitry 110 may determine, based on signals 120 from sensor(s) 116, a presence of obstacle(s) 106 in front of ownship vehicle 102. Processing circuitry 110 may determine, based on signals 120, a location of obstacle(s) 106 relative to ownship vehicle 102. Processing circuitry 110 may cause communications circuitry 112 to transmit the location of obstacle(s) 106 to external computing system 118.

In some examples, where there is no LoS or degradation of signal along communications channel 122, processing circuitry 110 may receive, via communications circuitry 112, instructions to perform maneuver 124B to avoid obstacle(s) 106. Processing circuitry 110 may then operate one or more control elements of ownship vehicle 102 to perform maneuver 124B. Maneuver 124B may include one or more of a vertical component (e.g., a change in a yaw of ownship vehicle 102) or a horizontal component (e.g., a change in a roll and/or pitch of ownship vehicle 102). After maneuver 124B is completed, processing circuitry 110 may receive instructions to perform maneuver 124C from external computing system 118 (e.g., to return to planned route 123). Processing circuitry 110 may then operate one or more control elements of ownship vehicle 102 to perform maneuver 124C. One or more components of maneuver 124C (e.g., horizontal component, vertical component) may be the same as or different from maneuver 124A. When onboard computing system 108 is operating ownship vehicle 102 in accordance with received operator instructions from external computing system 118, onboard computing system 108 may be described herein as operating in a “remote operation mode.”

In some examples, where there is a LoS and/or degradation of signal along communications channel 122, processing circuitry 110 may autonomously operate ownship vehicle 102. When onboard computing system 108 is autonomously operating ownship vehicle 102, onboard computing system 108 may be alternatively referred to herein as being in an “autonomous operation mode.” In the autonomous operation mode, processing circuitry 110 may determine the position of obstacle(s) 106 and, in response, retrieve and execute instructions stored in memory 114 to determine maneuver 124B to avoid obstacle(s) 106. In some examples, onboard computing system 108 may navigate or operate ownship vehicle 102 with reduced functionality compared to external computing system 118.In the autonomous operation mode, maneuver 124B may be more limited than a maneuver performed under remote operation mode in response to a same obstacle(s) 106. For example, in the autonomous operation mode, maneuver 124B may be limited in one or more aspects of maneuver 124B (e.g., a limit on a number of actions performed by ownship vehicle 102 through maneuver 124B, a limit on a magnitude of each action performed by ownship vehicle 102 throughout maneuver 124B, an inhibition on a change to a horizontal component of the travel ownship vehicle 102 through maneuver 124B). The restrictions to maneuver 124B while processing circuitry 110 is autonomously operating ownship vehicle 102 may reduce a likelihood of a collision between ownship vehicle 102 and another object (e.g., another obstacle, ground 104, other vehicles) while ownship vehicle 102 performed maneuver 124B.

In the autonomous operation mode, after maneuver 124B is performed, processing circuitry 110 may determine maneuver 124C, e.g., to return ownship vehicle 102 to planned route 123). Maneuver 124C may be restricted in a same or similar manner as maneuver 124B. For example maneuver 124C may be limited via one or more of a limit on a number of actions performed by ownship vehicle 102 through maneuver 124C, a limit on a magnitude of each action performed by ownship vehicle 102 throughout maneuver 124B, an inhibition on a change to a horizontal component of the travel ownship vehicle 102 through maneuver 124B.

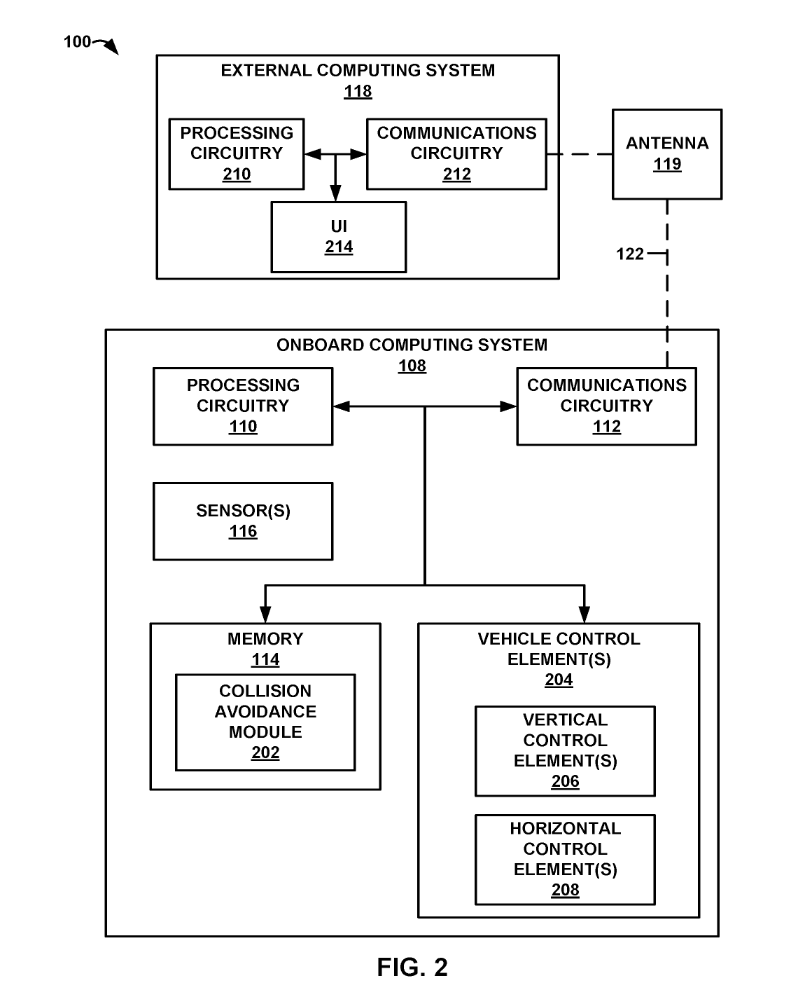

FIG. 2 is a block diagram illustrating an example of system 100 of FIG. 1. Although FIG. 2 illustrates system 100 as including two sub-systems (i.e., onboard computing system 108, external computing system 118), other examples of system 100 may include the components illustrated herein being disposed in two or more separate computing devices, computing systems, and/or cloud computing environments internal or external to ownship vehicle 102.

Onboard computing system 108 may include components including, but are not limited to, processing circuitry 110, communications circuitry 112, memory 114, sensor(s) 116, and vehicle control element(s) 204. Memory 114 may include one or more modules including, but not limited to, collision avoidance module 202. Vehicle control element(s) 204 may include vertical control element(s) 206 and horizontal control element(s) 208.

External computing system 118 may include components including, but are not limited to, processing circuitry 210, communications circuitry 212, and user interface (UI) 214. Communications circuitry 212 of external computing system 118 may be in communication with communications circuitry 112 of onboard computing system 108 via antenna 119.

Each of processing circuitry 110 or processing circuitry 210 may include any one or more of a microcontroller (MCU) (e.g., a computer on a single integrated circuit containing a processor core, memory, and programmable input/output peripherals), a microprocessor (µP) (e.g., a central processing unit (CPU) on a single integrated circuit (IC), a controller, a digital signal processor (DSP), an application specific integrated circuit (ASIC), a field-programmable gate array (FPGA), a system on chip (SoC), or equivalent discrete or integrated logic circuitry. A processor may be integrated circuitry, i.e., integrated processing circuitry, and that the integrated processing circuitry may be realized as fixed hardware processing circuitry, programmable processing circuitry, and/or a combination of both fixed and programmable processing circuitry. Accordingly, the terms “processing circuitry,” “processor,” or “controller,” as used herein, may refer to any one or more of the foregoing structures or any other structure operable to perform techniques described herein.

Memory 114 may include any type of non-transitory computer-readable storage media, such as random-access memory (RAM), read-only memory (ROM), programmable read-only memory (PROM), erasable programmable read-only memory (EPROM), one-time programmable (OTP) memory, electronically erasable programmable read-only memory (EEPROM), flash memory, or another type of volatile or non-volatile memory device. In some examples, the computer readable storage media of memory 114 may store instructions that cause processing circuitry 110 to execute the functions described herein. Memory 114 may include a plurality of modules including, but not limited to, collision avoidance module 202. The instructions for processing circuitry 110 may be stored within one or more modules of memory 114, e.g., within collision avoidance module 202.

Communications circuitry 112, communications circuitry 212, and antenna 119 may establish communications channel 122 between external computing system 118 and onboard computing system 108. Antenna 119 may be integral to external computing system 118 or may be separated from external computing system 118. Communications circuitry 112, communications circuitry 212, and antenna 119 may communicate via one or more wireless communication protocols including radio control protocols such as one or more of: pulse width modulation (PWM), pulse-position modulation (PPM), combined pulse-position modulation (CPPM), serial bus (SBUS), dynamic spectrum management (DSM), or the like.

Vehicle control element(s) 204 may include one or more control elements to adjust horizontal and/or vertical movement of ownship vehicle 102. Vehicle control element(s) 204 may include, but are not limited to, engines, brakes, rotors, control surfaces, propellers, wheels, or the like. Vehicle control element(s) 204 may include vertical control element(s) 206 and/or horizontal control element(s) 208. In some examples, where ownship vehicle 102 is an aircraft, vertical control element(s) 206 may include elevator(s) and horizonal control element(s) 208 may include rudders and ailerons.

An external operator of ownship vehicle 102 may interact with external computing system 118 via UI 214 of external computing system 118. UI 214 may output information (e.g., from ownship vehicle 102, from one or more other computing systems in communication with external computing system 118) as a visual, audio, or tactile signal. The information may indicate, but is not limited to, one or more of a status of ownship vehicle 102, location of ownship vehicle 102, planned route 123 of ownship vehicle 102, instrument reading(s) of ownship vehicle 102, or locations of other objects (e.g., obstacle(s) 106, ground 104, other vehicles) relative to ownship vehicle 102. UI 214 may output the information via one or more displays, speakers, haptic feedback devices or the like. The display(s), speaker(s), and/or haptic feedback device(s) may be disposed within a computing device coupled to external computing system 118. The computing device may include, but is not limited to, a personal computer, a laptop computer, or a tablet.

External computing system 118 may receive input from the operator via UI 214. The operator input may include commands from the operator to ownship vehicle 102 to control operation of ownship vehicle 102. In some examples, the operator input includes changes to planned route 123. UI 214 may include one or more elements configured to receive the operator input. The one or more elements may include, but are not limited to, microphones, cameras, keyboards, keypads, buttons, levers, switches, knobs, joysticks, or the like. Processing circuitry 210 may receive the operator input from UI 214. In some examples, processing circuitry 210 may convert the received operator input into instructions usable by onboard computing system 108 to adjust operation of ownship vehicle 102, e.g., in accordance with the received operator input. Processing circuitry 210 may cause communications circuitry 212 to transmit information indicating the operator input to onboard computing system 108 through communications channel 122 (e.g., via communications channel 122 between antenna 119 and communications circuitry 112. The information transmitted by communications circuitry 212 may be the direct inputs from the operator or may be at least partially converted from the direct inputs.

Processing circuitry 110 of onboard computing system 108 may receive, via communications circuitry 112, the operator instructions (e.g., direct operator inputs, at least partially converted operator inputs) from external computing system 118. Based on the received instructions, processing circuitry 110 may operate ownship vehicle 102 in the remote operation mode. For example, processing circuitry 110 may transmit instructions to vehicle control element(s) 204 of ownship vehicle 102 (e.g., to one or more of vertical control element(s) 206 or horizontal control element(s) 208) to operate ownship vehicle 102 in accordance with operator instructions.

Processing circuitry 110 may receive sensed signals 120 (not pictured in FIG. 2) from sensor(s) 116 and may transmit signals 120 to external computing system 118 via communications circuitry 112. Processing circuitry 210 may cause UI 214 to output at least a portion of signals 120 and/or information determined based on signals 120 on UI 214. Sensor(S) 116 may include, but are not limited to, (Global Positioning System) GPS sensors, radar receivers, Light Detection and Ranging (LiDAR) sensors, accelerometers, pressure gauges, temperature sensors, gyroscopes, inertial measurement units (IMUs), angle of attack (AoA) sensors, electro-optical cameras, infrared cameras, or the like.

Processing circuitry 110 may monitor a status of communications channel 122 with external computing system 118 for degradation and/or LoS in communications channel 122. In the event of a degradation and/or LoS in communications channel 122, processing circuitry 110 may retrieve and execute instructions stored in memory 114 to autonomously operate ownship vehicle 102, e.g., based on signals 120 from sensor(s) 116 in the autonomous operation mode. Switching to autonomous operation in the event of a degradation and/or LoS in communications channel 122 may allow ownship vehicle 102 to be operated and/or for ownship vehicle 102 to avoid obstacles (e.g., obstacle(s) 106) in the event of an inability for the operator to control ownship vehicle 102 (e.g., due to the LoS with ownship vehicle 102).

Processing circuitry 110 may determine that the status of communications channel 122 is sufficient to switch onboard computing system 108 to the autonomous operation mode based on a determination of a complete or partial loss of signal between onboard computing system 108 and external computing system 118. In some examples, processing circuitry 110 determines that the status of communications channel 122 is sufficient to switch onboard computing system 108 to the autonomous operation mode based on a determination of a presence of interference (e.g., noise, other communications signals) between onboard computing system 108 and external computing system 118 (e.g., along communications channel 122).

Processing circuitry 110 may determine a duration since receipt of a last communication from external computing system 118 and determine degradation and/or LoS in communication channel 122 based on a determination that the determined duration is greater than or equal to a threshold duration stored in memory 114. In some examples, processing circuitry 110 transmit, via communications circuitry 112, queries to external computing system 118 and monitors responses from external computing system 118 in response to the queries. The queries may be as a part of transmission of other information (e.g., signals 120) to external computing system 118 and/or may be a periodic query (e.g., transmitted by communications circuitry 112 after a specific time duration after a previously-transmitted query has elapsed). The specific time duration may be dependent on the characteristics of ownship vehicle 102 and/or an operational context for ownship vehicle 102. In such examples, processing circuitry 110 may determine the presence of a degradation and/or LoS in communications channel 122 based on a determination of one or more of: at least a threshold percentage of queries within a specific time period has not been answered by external computing system 118, or that there are delays of at least a threshold duration between each query and the corresponding response for a threshold number of queries within the specific time period.

While onboard computing system 108 is in the autonomous operation mode, processing circuitry 110 may cause communications circuitry 112 to transmit queries (e.g., periodically, continuously). Processing circuitry 110 may receive responses to one or more queries from external computing system 118 (e.g., via communications channel 122) and may determine, based on receiving the responses, that ownship vehicle 102 is in communication with external computing system 118. Processing circuitry 110 may then revert onboard computing system 108 back to a remote operation mode, where processing circuitry 110 receives and executes instructions from external computing system 118 to operate ownship vehicle 102 in accordance with operator input. In some examples, processing circuitry 110 may revert onboard computing system 108 back to the remote operation mode based on a determination that there is no longer interference or an at least partial loss of signal between onboard computing system 108 and external computing system 118.

Processing circuitry 110 may determine, based on signals 120, a presence of obstacle(s) 106 in front of ownship vehicle 102. Processing circuitry 110 may determine characteristics of obstacle(s) 106 (e.g., size, height, location) based on signals 120. Processing circuitry 110 may transmit signals 120, presence of obstacle(s) 106, and/or characteristics of obstacle(s) 106 to external computing system 118 via communications circuitry 112.

When onboard computing system 108 is in the remote operation mode, processing circuitry 110 may operate vehicle control element(s) 204 in accordance with received operator instructions to perform maneuver 124B and avoid obstacle(s) 106. In some examples, processing circuitry 110 and/or 210 compares maneuver 124B against the characteristics of obstacle(s) 106 (e.g., size, height) and outputs an alert (e.g., via UI 214) based on a determination that maneuver 124B may cause ownship vehicle 102 to collide with obstacle(s) 106. When onboard computing system 108 is in the remote operation mode, processing circuitry 110 may transmit instructions to vertical control element(s) 206 and/or to horizontal control element(s) 208 of vehicle control element(s) 204 to perform maneuver 124B. Thus, in the remote operation mode, maneuver 124B executed by ownship vehicle 102 to avoid obstacle(s) 106 may include both a vertical component (e.g., changes in the yaw of ownship vehicle 102) and a horizontal component (e.g., changes in the roll and/or the pitch of ownship vehicle 102).

When onboard computing system 108 is in the autonomous operation mode, processing circuitry 110 may retrieve and execute instructions stored in collision avoidance module 202 of memory 114 to generate maneuver 124B. The instructions stored in collision avoidance module 202 may be the same as or similar to instructions for application of a Traffic Alert and Collision Avoidance System (TCAS) to avoid an obstacle. Processing circuitry 110 may generate maneuver 124B based on signals 120 from sensor(s) 116. Processing circuitry 110 may limit maneuver 124B to only vertical maneuvers (e.g., changes in the yaw of ownship vehicle 102). In such examples, processing circuitry 110 may only operate vertical control element(s) 206 of ownship vehicle 102 to perform maneuver 124B. Limiting maneuver 124B in the autonomous operation mode to only vertical maneuvers may allow ownship vehicle 102 to avoid obstacle(s) 106 without increasing a likelihood of collision between ownship vehicle 102 and another obstacle. Limiting maneuver 124B in the autonomous operation mode may also reduce risks to ownship vehicle 102, e.g., due to performance degradation by ownship vehicle 102 and/or due to wear and/or failure of components (e.g., engine(s)) of ownship vehicle 102.

In some examples, onboard computing system 108 may re-establish communications channel 122 with external computing system 118 during executing of maneuver 124B. In such examples, processing circuitry 110 may continue to autonomously perform maneuver 124B until maneuver 124B is completed, e.g., even if processing circuitry 110 receives contrary instructions from external computing system 118. Processing circuitry 110 may cause communications circuitry 112 to transmit a notification to external computing system 118 indicating that ownship vehicle 102 is performing maneuver 124B. The notification may include parameters of and/or actions within maneuver 124B. External computing system 118 may output the notification to the operator via UI 214.

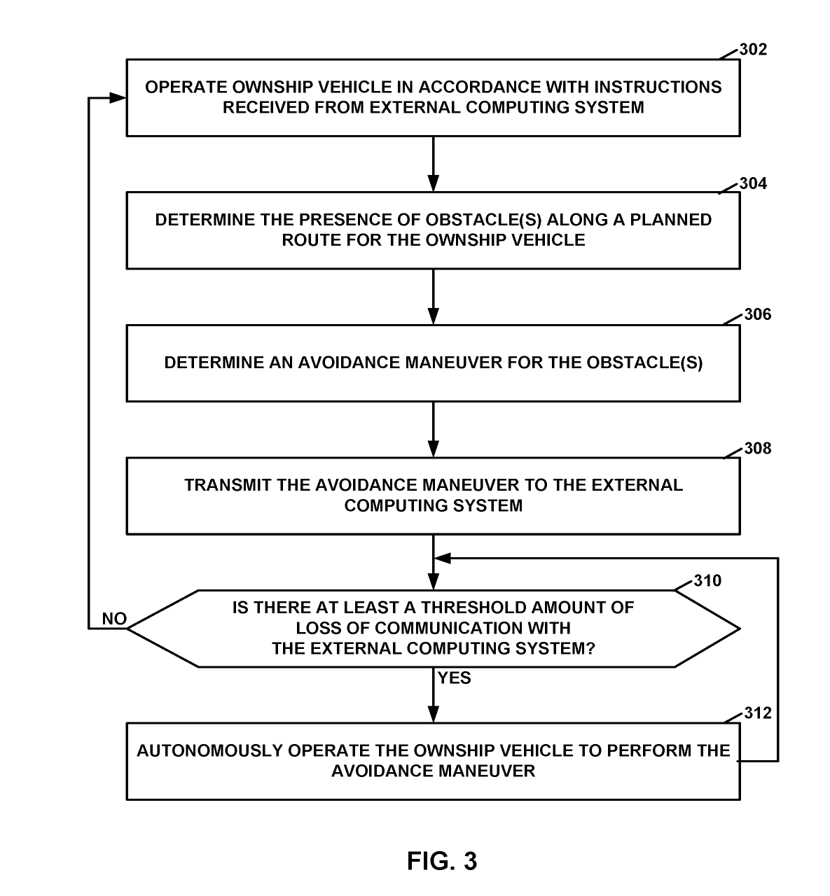

FIG. 3 is a flow chart illustrating an example technique for avoiding obstacle(s) 106 by ownship vehicle operation system 100 of FIGS. 1-2. While the technique illustrated in FIG. 3 is primarily described with respect to system 100 illustrated in FIGS. 1-2, the technique may be performed by any example ownship vehicle operation system described herein. While the technique is illustrated in FIG. 3 with the steps in one particular order, the technique may be performed with the steps in other orders.

Onboard computing system 108 (e.g., processing circuitry 110 of onboard computing system 108) may operate ownship vehicle 102 in accordance with instructions received from external computing system 118 (302). Onboard computing system 108 may receive instructions from external computing system 118 via communications circuitry 112. Communications circuitry 112 may be in wireless communication with antenna 119 through communications channel 122. External computing system 118 may output the instructions through communications channel 122 via antenna 119. The instructions may include operator input received by external computing system 118 from an external operator. As onboard computing system 108 receives instructions from the operator, onboard computing system 108 may adjust vehicle control element(s) 204 of ownship vehicle 102 to operate ownship vehicle 102 and/or cause ownship vehicle 102 to perform maneuvers in accordance with the instructions. In such examples, onboard computing system 108 may be operating in the remote operation mode.

Onboard computing system 108 may determine the presence of obstacle(s) 106 along a planned route 123 for ownship vehicle 102 (304). Ownship vehicle 102 may include sensor(s) 116. Sensor(s) 116 may output signals 120 to processing circuitry 110 of onboard computing system 108. Signals 120 may indicate the presence of obstacle(s) 106 in a vicinity of ownship vehicle 102 (e.g., in front of ownship vehicle 102). Obstacle(s) 106 may include terrain features, no-fly zones, avoidance zones, other vehicles, structures, or the like. Processing circuitry 110 may identify characteristics of obstacle(s) 106 (e.g., size, height, location) based at least in part on signals 120. In some examples, processing circuitry 110 causes communications circuitry 112 to transmit signals 120, a presence of obstacle(s) 106, and/or the identified characteristics of obstacle(s) 106 to external computing system 118. External computing system 118 may then display the received information to the operator, e.g., to notify the operator of obstacle(s) 106.

Onboard computing system 108 may determine an avoidance maneuver 124B for obstacle(s) 106 (306). Onboard computing system 108 may transmit the avoidance maneuver to external computing system 118, e.g., via communications circuitry 112 (308). Processing circuitry 110 may retrieve and execute instructions stored in collision avoidance module 202 of memory 114 of onboard computing system 108 to determine maneuver 124B. The instructions stored in collision avoidance module 202 may be the same as or similar to instructions to avoid an obstacle in accordance with a TCAS. Processing circuitry 110 may determine maneuver 124B based at least in part on the identified characteristics of obstacle(s) 106. Ownship vehicle 102 may avoid collision with obstacle(s) 106 by executing maneuver 124B. Maneuver 124B may include a change to vertical and/or to horizontal movement of ownship vehicle 102.

In some examples, processing circuitry 110 generates a plurality of possible maneuvers 124B. In such examples, one or more maneuvers 124B of the plurality of possible maneuvers 124B may be configured to be performed by onboard computing system 108 in remote operation mode and one or more other maneuvers 124B of the plurality of possible maneuvers 124B may be configured to be performed by onboard computing system 108 in autonomous operation mode. Maneuvers 124B configured to be performed in remote operation mode may include changes to vertical and/or horizontal movement of ownship vehicle 102, may include larger changes in magnitude to vertical and/or horizontal movement of ownship vehicle 102, and/or may include a larger number of changes to movement of ownship vehicle 102 within maneuver 124B. Maneuvers 124B configured to be performed in autonomous operation mode may be limited to changes to the vertical movement of ownship vehicle 102, may include smaller changes in magnitude to the vertical movement of ownship vehicle 102, and/or may include a limited number of changes to movement of ownship vehicle 102 within maneuver 124B.

Onboard computing system 108 may determine whether there is at least a threshold amount of loss of communications with external computing system 118 (310). Onboard computing system 108 may evaluate the presence of loss of communications with external computing system 118 based on a presence of degradation or LoS between onboard computing system 108 and external computing system 118 across communications channel 122. The threshold amount of loss of communications may correspond to one or more of: a threshold delay between a transmission (e.g., a query) from onboard computing system 108 to external computing system 118 and a response from external computing system 118, a lack of response from external computing system 118 in response to the transmission, a lack of response or a delayed response for at least a threshold number of transmissions within a threshold time period, or any other indicia of a LoS between onboard computing system 108 and external computing system 118.

Based on a determination that there is less than the threshold amount of loss of communication with external computing system 118 (“NO” branch of 310), onboard computing system 108 may continue to operate ownship vehicle 102 in accordance with instructions received from external computing system 118 (302). If onboard computing system 108 receives from external computing system 118 instructions indicating that the operator has selected a specific maneuver 124B generated by onboard computing system 108, onboard computing system 108 may operate vehicle control element(s) 204 to perform maneuver 124B. In some examples, onboard computing system 108 receives instructions indicating the operator has selected maneuver 124B not generated by onboard computing system 108 and may operate vehicle control element(s) 204 to perform maneuver 124B.

Based on a determination that there is at least the threshold amount of loss of communication with external computing system (“YES” branch of 310), onboard computing system 108 may autonomously operate ownship vehicle 102 to perform avoidance maneuver 124B (312). Onboard computing system 108 may switch from remote operation mode to autonomous operation mode to autonomously operate ownship vehicle 102, e.g., based on signals 120 from sensor(s) 116. In some examples, where onboard computing system 108 generated a plurality of maneuvers 124B, onboard computing system 108 may autonomously select and perform a specific maneuver 124B of the plurality of maneuvers 124B configured to autonomous execution.

Onboard computing system 108 may reestablish communications with external computing system 118 during or after execution of maneuver 124B. For example, onboard computing system 108, may determine, during or after execution of maneuver 124B, that there is less than the threshold amount of loss of communication with external computing system 118. Based on the determination, onboard computing system 108 may revert from the autonomous operation mode to the remote operation mode and operate ownship vehicle in accordance with instructions received from external computing system 118 (302). If onboard computing system 108 reestablishes communications with external computing system 118 during execution of maneuver 124B, onboard computing system 108 may continue to autonomously operate ownship vehicle 102 to complete maneuver 124B, e.g., even if onboard computing system 108 receives different instructions from external computing system 118. Onboard computing system 108 may transmit a notification to external computing system 118 indicating the parameters of maneuver 124B (e.g., an amount and/or type of movement by ownship vehicle 102 during maneuver 124B).

While the technique illustrated in FIG. 3 is primarily described above with having ownship vehicle 102 generate avoidance maneuvers 124B prior to determination of a loss of communication between onboard computing system 108 and external computing system 118, in other examples onboard computing system 108 may only generate avoidance maneuvers 124B in the autonomous operation mode, e.g., after a determination that there is at least the threshold amount of loss of communication with external computing system 118.

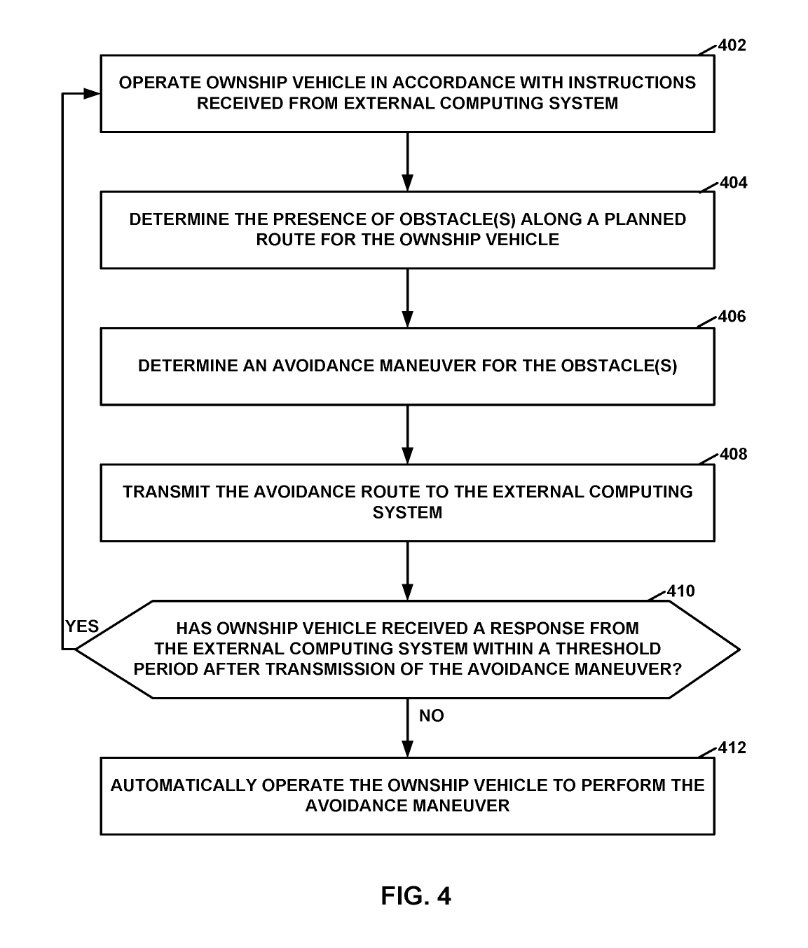

FIG. 4 is a flow chart illustrating an example technique for operating the ownship vehicle by the ownship vehicle operation system of FIGS. 1-2. While the technique illustrated in FIG. 4 is primarily described with respect to system 100 illustrated in FIGS. 1-2, the technique may be performed by any example ownship vehicle operation system described herein. While the technique is illustrated in FIG. 4 with the steps in one particular order, the technique may be performed with the steps in other orders.

Onboard computing system 108 may operate ownship vehicle 102 in accordance with instructions received from external computing system 118 (402). Onboard computing system 108 may determine the presence of obstacle(s) 106 along planned route 123 for ownship vehicle 102 (404). Onboard computing system 108 may determine an avoidance maneuver 124B for obstacle(s) 106 (406). Onboard computing system 108 may transmit avoidance maneuver 124B to external computing system 118 (408). Onboard computing system 108 may perform any of steps 402–408 in accordance with the techniques previously described herein, e.g., with respect to FIG. 3.

Onboard computing system 108 may determine whether ownship vehicle 102 has received a response from external computing system 118 within a threshold period after transmission of avoidance maneuver 124B (410). The response from external computing system 118 may indicate an approval of maneuver 124B by the operator and/or a confirmation that external computing system 118 has received maneuver 124B. The threshold period may be dependent on the characteristics of ownship vehicle 102 and/or an operational context for ownship vehicle 102. Receipt of the response from external computing system 118 within the threshold period may indicate that there is no degradation or loss of signal in communication channel 122. A delay in the response and/or no response from external computing system 118 may indicate a degradation in communication channel 122 and/or a loss of signal between onboard computing system 108 and external computing system 118.

Based on a determination that ownship vehicle 102 has received a response from external computing system 118 within the threshold period (“YES” branch of 410), onboard computing system 108 may operate ownship vehicle 102 in accordance with instructions received from external computing system 118 (402). Based on a determination that ownship vehicle has not received a response from external computing system 118 within the threshold period (“NO” branch of 410), onboard computing system 118 may autonomously operate ownship vehicle to perform avoidance maneuver 124B (412).

The techniques of this disclosure may also be described in the following examples.

Example 1: an onboard computing system of an ownship vehicle, the onboard computing system comprising: communications circuitry; and processing circuitry configured to: determine a presence of an obstacle in a planned route for the ownship vehicle; determine an avoidance route for the obstacle; transmit, via the communications circuitry, the avoidance route to an external computing system; determine whether the onboard computing system is in communication with the external computing system; in response to a determination that the onboard computing system is in communication with the external computing system, cause the ownship vehicle to avoid the obstacle based on information received via the communications circuitry from the external computing system; and in response to a determination that the onboard computing system is not in communication with the external computing system, cause the ownship vehicle to proceed along the avoidance route, the avoidance route comprising a change to a vertical component of the planned route.

Example 2: the onboard computing system of example 1, further comprising one or more sensors, and wherein the processing circuitry is configured to determine the presence of the obstacle based on sensed information from the one or more sensors.

Example 3: the onboard computing system of any of examples 1 and 2, wherein the avoidance route comprises a same horizontal component as a horizontal component of the planned route.

Example 4: the onboard computing system of any of examples 1–3, wherein to determine that the onboard computing system is not in communication with the external computing system, the processing circuitry is configured to determine one or more of: a loss of signal between the processing circuitry and the external computing system; a delay in response between the processing circuitry and the external computing system; or a presence of interference in a data link between the processing circuitry and the external computing system.

Example 5: the onboard computing system of any of examples 1–4, wherein the processing circuitry is further configured to: determine that the onboard computing system has regained communications with the external computing system; and in response to a determination that the onboard computing system has regained communications with the external computing system, transmit, via the communications circuitry, a notification indicating that the ownship vehicle is proceeding along the avoidance route.

Example 6: the onboard computing system of any of examples 1–5, wherein the processing circuitry is further configured to: determine that the onboard computing system has regained communications with the external computing system; determine that the ownship vehicle has not completed the avoidance route; and in response to a determination that the ownship vehicle has not completed the recommended avoidance route, cause the ownship vehicle to complete the avoidance route.

Example 7: the onboard computing system of example 6, wherein the processing circuitry is further configured to: in response to causing the ownship vehicle to complete the avoidance route, cause the communications circuitry to transmit a notification indicating that the ownship vehicle is being controlled by the processing circuitry.

Example 8: the onboard computing system of any of examples 1–7, wherein the processing circuitry is configured to determine the avoidance route in accordance with a Traffic Alert and Collision Avoidance System (TCAS) protocol.

Example 9: the onboard computing system of any of examples 1–8, wherein the obstacle comprises: one or more features in a terrain along or near the planned route for the ownship vehicle; or one or more other vehicles along or near the planned route for the ownship vehicle.

Example 10: the onboard computing system of any of examples 1–9, wherein in response to a determination that the onboard computing system is in communication with the external computing system, the processing circuitry is configured to navigate the ownship vehicle based on the information received via the communications circuitry from the external computing system in a remote operation mode, wherein in response to a determination that the onboard computing system is not in communication with the external computing system, the processing circuitry is configured to autonomously navigate the ownship vehicle in an autonomous operation mode, and wherein in the autonomous operation mode, the processing circuitry is configured to navigate the ownship vehicle with reduced functionality compared to the remote operation mode.

Example 11: a method comprising: determining, by processing circuitry of an onboard computing system of an ownship vehicle, a presence of an obstacle in a planned route; determining, by the processing circuitry, an avoidance route for the obstacle; transmitting, by the processing circuitry and via communications circuitry of the onboard computing system, the avoidance route to an external computing system; determining, by the processing circuitry, whether the onboard computing system is in communication with the external computing system; causing, by the processing circuitry and in response to a determination that the onboard computing system is in communication with the external computing system, the ownship vehicle to avoid the obstacle based on information received from the external computing system via the communications circuitry; and causing, by the processing circuitry and in response to a determination that the onboard computing system is not in communication with the external computing system, the ownship vehicle to proceed along the avoidance route, wherein the avoidance route comprises a change to a vertical component of the planned route.

Example 12: the method of example 11, wherein determining the presence of the obstacle comprises, determining, by the processing circuitry, the presence of the obstacle based on sensed information from one or more sensors of the ownship vehicle.

Example 13: the method of any of examples 11 and 12, wherein the avoidance route comprises a same horizontal component as a horizontal component of the planned route.

Example 14: the method of any of examples 11–13, wherein determining that the onboard computing system is not in communication with the external computing system comprises determining, by the processing circuitry, one or more of: a loss of signal between the processing circuitry and the external computing system; a delay in response between the processing circuitry and the external computing system; or a presence of interference in a data link between the processing circuitry and the external computing system.

Example 15: the method of any of examples 11–14, further comprising: determining, by the process circuitry, that the onboard computing system has regained communications with the external computing system; and in response to a determination that the onboard computing system has regained communications with the external computing system, transmitting, by the processing circuitry and via the communications circuitry, a notification indicating that the ownship vehicle is proceeding along the avoidance route.

Example 16: the method of any of examples 11–15, further comprising: determining, by the processing circuitry, that the onboard computing system has regained communications with the external computing system; determining, by the processing circuitry, that the ownship vehicle has not completed the avoidance route; and in response to a determination that the ownship vehicle has not completed the avoidance route, causing, by the processing circuitry, the ownship vehicle to complete the avoidance route.

Example 17: a computer-readable medium comprising instructions that, when executed by processing circuitry of a onboard computing system of an ownship vehicle, causes the processing circuitry to: determine a presence of an obstacle in a planned route for the ownship vehicle; determine an avoidance route for the obstacle; transmit, via communications circuitry of the onboard computing system, the avoidance route to an external computing system; determine whether the onboard computing system is in communication with the external computing system; in response to a determination that the onboard computing system is in communication with the external computing system, cause the ownship vehicle to avoid the obstacle based on information received via the communications circuitry from the external computing system; and in response to a determination that the onboard computing system is not in communication with the external computing system, cause the ownship vehicle to proceed along the avoidance route, the avoidance route comprising a change to a vertical component of the planned route.

Example 18: the computer-readable medium of example 17, wherein the instructions are configured to cause the processing circuitry to determine that the onboard computing system is not in communication with the external computing system by determining one or more of: a loss of signal between the processing circuitry and the external computing system; a delay in response between the processing circuitry and the external computing system; or a presence of interference in a data link between the processing circuitry and the external computing system.

Example 19: the computer-readable medium of any of examples 17 and 18, further comprising instructions that, when executed by the processing circuitry, causes the processing circuitry to: determine that the onboard computing system has regained communications with the external computing system; and in response to a determination that the onboard computing system has regained communications with the external computing system, transmit, via the communications circuitry, a notification indicating that the ownship vehicle is proceeding along the avoidance route.

Example 20: the computer-readable medium of any of examples 17–19, further comprising instructions that, when executed by the processing circuitry, causes the processing circuitry to: determine that the onboard computing system has regained communications with the external computing system; determine that the ownship vehicle has not completed the avoidance route; and in response to a determination that the ownship vehicle has not completed the avoidance route, cause the ownship vehicle to complete the avoidance route.

In one or more examples, the functions described above may be implemented in hardware, software, firmware, or any combination thereof. For example, the various components of onboard computing system 108 and/or external computing system 118 may be implemented in hardware, software, firmware, or any combination thereof. If implemented in software, the functions may be stored on or transmitted over, as one or more instructions or code, a computer-readable medium and executed by a hardware-based processing unit. Computer-readable media, e.g., memory 114, may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

The term “non-transitory” may indicate that the storage medium is not embodied in a carrier wave or a propagated signal. In certain examples, a non-transitory storage medium may store data that can, over time, change (e.g., in RAM or cache). By way of example, and not limitation, such computer-readable storage media, may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor” and “processing circuitry,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. These and other examples are within the scope of the following claims.

What is claimed is:

1. An onboard computing system of an ownship vehicle, the onboard computing system comprising:
communications circuitry; and
processing circuitry configured to:
determine a presence of an obstacle in a planned route for the ownship vehicle;
determine an avoidance route for the obstacle;
transmit, via the communications circuitry, the avoidance route to an external computing system; determine whether the onboard computing system is in communication with the external computing system;
in response to a determination that the onboard computing system is in communication with the external computing system, cause the ownship vehicle to avoid the obstacle based on information received via the communications circuitry from the external computing system; and
in response to a determination that the onboard computing system is not in communication with the external computing system, cause the ownship vehicle to proceed along the avoidance route, the avoidance route comprising a change to a vertical component of the planned route.

2. The onboard computing system of claim 1 further comprising one or more sensors, and wherein the processing circuitry is configured to determine the presence of the obstacle based on sensed information from the one or more sensors.

3. The onboard computing system of claim 1, wherein the avoidance route comprises a same horizontal component as a horizontal component of the planned route.

4. The onboard computing system of claim 1, wherein to determine that the onboard computing system is not in communication with the external computing system, the processing circuitry is configured to determine one or more of:
a loss of signal between the processing circuitry and the external computing system;
a delay in response between the processing circuitry and the external computing system; or
a presence of interference in a data link between the processing circuitry and the external computing system.

5. The onboard computing system of claim 1, wherein the processing circuitry is further configured to:
determine that the onboard computing system has regained communications with the external computing system; and
in response to a determination that the onboard computing system has regained communications with the external computing system, transmit, via the communications circuitry, a notification indicating that the ownship vehicle is proceeding along the avoidance route.

6. The onboard computing system of claim 1, wherein the processing circuitry is further configured to:
determine that the onboard computing system has regained communications with the external computing system;
determine that the ownship vehicle has not completed the avoidance route; and
in response to a determination that the ownship vehicle has not completed the recommended avoidance route, cause the ownship vehicle to complete the avoidance route.

7. The onboard computing system of claim 6, wherein the processing circuitry is further configured to:
in response to causing the ownship vehicle to complete the avoidance route, cause the communications circuitry to transmit a notification indicating that the ownship vehicle is being controlled by the processing circuitry.

8. The onboard computing system of claim 1, wherein the processing circuitry is configured to determine the avoidance route in accordance with a Traffic Alert and Collision Avoidance System (TCAS) protocol.

9. The onboard computing system of claim 1, wherein the obstacle comprises:
one or more features in a terrain along or near the planned route for the ownship vehicle; or
one or more other vehicles along or near the planned route for the ownship vehicle.

10. The onboard computing system of claim 1,
wherein in response to a determination that the onboard computing system is in communication with the external computing system, the processing circuitry is configured to navigate the ownship vehicle based on the information received via the communications circuitry from the external computing system in a remote operation mode,
wherein in response to a determination that the onboard computing system is not in communication with the external computing system, the processing circuitry is configured to autonomously navigate the ownship vehicle in an autonomous operation mode, and
wherein in the autonomous operation mode, the processing circuitry is configured to navigate the ownship vehicle with reduced functionality compared to the remote operation mode.

11. A method comprising:
determining, by processing circuitry of an onboard computing system of an ownship vehicle, a presence of an obstacle in a planned route;
determining, by the processing circuitry, an avoidance route for the obstacle;
transmitting, by the processing circuitry and via communications circuitry of the onboard computing system, the avoidance route to an external computing system;
determining, by the processing circuitry, whether the onboard computing system is in communication with the external computing system;
causing, by the processing circuitry and in response to a determination that the onboard computing system is in communication with the external computing system, the ownship vehicle to avoid the obstacle based on information received from the external computing system via the communications circuitry; and
causing, by the processing circuitry and in response to a determination that the onboard computing system is not in communication with the external computing system, the ownship vehicle to proceed along the avoidance route, wherein the avoidance route comprises a change to a vertical component of the planned route.

12. The method of claim 11, wherein determining the presence of the obstacle comprises, determining, by the processing circuitry, the presence of the obstacle based on sensed information from one or more sensors of the ownship vehicle.

13. The method of claim 11, wherein the avoidance route comprises a same horizontal component as a horizontal component of the planned route.

14. The method of claim 11, wherein determining that the onboard computing system is not in communication with the external computing system comprises determining, by the processing circuitry, one or more of:
a loss of signal between the processing circuitry and the external computing system;
a delay in response between the processing circuitry and the external computing system; or
a presence of interference in a data link between the processing circuitry and the external computing system.

15. The method of claim 11, further comprising:
determining, by the process circuitry, that the onboard computing system has regained communications with the external computing system; and
in response to a determination that the onboard computing system has regained communications with the external computing system, transmitting, by the processing circuitry and via the communications circuitry, a notification indicating that the ownship vehicle is proceeding along the avoidance route.

16. The method of claim 11, further comprising:
determining, by the processing circuitry, that the onboard computing system has regained communications with the external computing system;
determining, by the processing circuitry, that the ownship vehicle has not completed the avoidance route; and
in response to a determination that the ownship vehicle has not completed the avoidance route, causing, by the processing circuitry, the ownship vehicle to complete the avoidance route.

17. A computer-readable medium comprising instructions that, when executed by processing circuitry of a onboard computing system of an ownship vehicle, causes the processing circuitry to:
determine a presence of an obstacle in a planned route for the ownship vehicle;
determine an avoidance route for the obstacle;
transmit, via communications circuitry of the onboard computing system, the avoidance route to an external computing system;
determine whether the onboard computing system is in communication with the external computing system;
in response to a determination that the onboard computing system is in communication with the external computing system, cause the ownship vehicle to avoid the obstacle based on information received via the communications circuitry from the external computing system; and
in response to a determination that the onboard computing system is not in communication with the external computing system, cause the ownship vehicle to proceed along the avoidance route, the avoidance route comprising a change to a vertical component of the planned route.

18. The computer-readable medium of claim 17, wherein the instructions are configured to cause the processing circuitry to determine that the onboard computing system is not in communication with the external computing system by determining one or more of:
a loss of signal between the processing circuitry and the external computing system;
a delay in response between the processing circuitry and the external computing system; or
a presence of interference in a data link between the processing circuitry and the external computing system.

19. The computer-readable medium of claim 17, further comprising instructions that, when executed by the processing circuitry, causes the processing circuitry to:
determine that the onboard computing system has regained communications with the external computing system; and
in response to a determination that the onboard computing system has regained communications with the external computing system, transmit, via the communications circuitry, a notification indicating that the ownship vehicle is proceeding along the avoidance route.

20. The computer-readable medium of claim 17, further comprising instructions that, when executed by the processing circuitry, causes the processing circuitry to:
determine that the onboard computing system has regained communications with the external computing system;
determine that the ownship vehicle has not completed the avoidance route; and
in response to a determination that the ownship vehicle has not completed the avoidance route, cause the ownship vehicle to complete the avoidance route.
